(19) United States
(12) Patent Application Publication
(10) Pub. No.: US 2003/0072056 A1
(43) Pub. Date: Apr. 17, 2003

(54) Wavelength division multiplexer and wavelength division multiplexing system

(76) Inventor: Takeshi Ota, Tokyo (JP)

Correspondence Address: NOTARO & MICHALOS P.C., Empire State Building, Suite 6902, 350 Fifth Avenue, New York, NY, 10118-6985, US

(21) Appl. No.: 10/266,247

(22) Filed: Oct. 8, 2002

(30) Foreign Application Priority Data
Oct. 12, 2001 (JP) 2001-314666
Jul. 31, 2002 (JP) 2002-224035

(51) Int. Cl. H04J 14/02

(52) U.S. Cl. 359/124

(57) ABSTRACT

A wavelength division multiplexer comprising three WDM optical fiber couplers connected in a tree-like configuration. Two multiplexed wavelengths λ2 and λ4 inputted through a common port are split and outputted separately via two branch ports. Wavelengths λ1 and λ3 inputted via two different branch ports are combined and outputted via the common port. The wavelengths λ1, λ2, λ3, and λ4 are set sequentially larger. Isolation between neighboring channels (wavelengths) is low, but isolation between one channel and the channel adjacent to the neighboring channel is sufficiently large. By transmitting light of neighboring channels in opposite directions on the same optical fiber, leakage of the optical signal does not occur even with a low isolation between neighboring channels.

### FIELD OF THE INVENTION

The present invention relates to a wavelength division multiplexer and a wavelength division multiplexing system, and particularly to a wavelength division multiplexer used in a coarse wavelength division multiplexing system designed for performing wavelength division multiplexing at coarsely spaced wavelengths for low-density requirements. The present invention also relates to a coarse wavelength division multiplexer.

### BACKGROUND OF THE INVENTION

Conventional wavelength division multiplexing systems use thin film filter type wavelength division multiplexers, such as those shown in FIGS. 10 and 11. As shown in FIG. 10, a conventional wavelength division multiplexer employing thin film filters is configured of three-port devices 100a through 100d connected in tandem. FIG. 11 shows the construction of one of these three-port devices 100. The three-port device 100 comprises an input port optical fiber 101, a pass port optical fiber 102, a reflected port optical fiber 103, collimator lenses 104 and 106, and a thin film filter 105. Light from the optical fiber 101 of the input port passes through the collimator lens 104 and shines on the thin film filter 105. The thin film filter 105 allows only light of a specific wavelength (λ) to pass. Light of the specific wavelength (λ) is guided through the collimator lens 106 to the optical fiber 102 of the pass port. Light of all wavelengths other than the specific wavelength (λ) is reflected by the thin film filter 105 back through the collimator lens 104 and guided to the optical fiber 103 of the reflected port. By configuring the thin film filter type wavelength division multiplexer of FIG. 10 with these three-port devices 100a through 100d connected in tandem, only specific wavelengths λ1 through λ4 are selectively outputted via the pass ports of each three-port filter.

A wavelength division multiplexer employing a fused type fiber coupler (WDM optical fiber coupler), such as that shown in FIG. 12, is also well known in the art. The wavelength division multiplexer comprises a WDM optical fiber coupler 110, an input port 111, a first port 112, and a second port 113. When light is inserted in the WDM optical fiber coupler 110 via the input port 111 (wavelengths λ1 and λ2), only light of the wavelength λ1 is guided to the first port 112 and only light of the wavelength λ2 is guided to the second port 113.

Although both the thin film filter type wavelength division multiplexer and the WDM optical fiber coupler type wavelength division multiplexer are designed to guide only a specific wavelength to a specific port, it is known in fact that a portion of the light leaks into ports adjacent to the intended port. The degree of this leakage is called isolation. For example, when 1/100 of the light leaks into an adjacent port, this degree of leakage is represented as 20 dB of isolation.

When employing three-port devices with thin film filters, conventional wavelength division multiplexers can achieve a satisfactory degree of isolation. However, these multiplexers are expense. On the other hand, wavelength division multiplexers employing WDM optical fiber couplers are low in cost, but have difficulty achieving sufficient isolation.

### SUMMARY OF THE INVENTION

In view of the foregoing, it is an object of the present invention to provide a wavelength division multiplexer that can achieve sufficient isolation at a low cost.

To attain the above object, a wavelength division multiplexer according to a first aspect of the present invention sets the isolation between neighboring wavelengths at a relatively lenient amount of 10-17 dB and sets the isolation between wavelengths adjacent to those neighboring wavelengths at 20 dB or greater. More specifically, the wavelength division multiplexer is configured to use neighboring wavelengths alternately as transmission wavelengths and reception wavelengths. Since high isolation is unnecessary between optical signals for transmission and reception, a wavelength division multiplexer having the above properties can be used to perform optical signal communications with no problem. Hence, it is possible to achieve a wavelength division multiplexer using a WDM optical fiber coupler to reduce costs. In other words, one characteristic of the present invention is to configure the wavelength division multiplexer to employ adjacent wavelengths alternately as transmission and reception wavelengths in order to make isolation restrictions between neighboring wavelengths more lenient and to increase isolation between wavelengths adjacent to the neighboring wavelengths.

A wavelength division multiplexer according to a second aspect of the present invention separates wavelengths of received optical signals using thin film filter type three-port devices and multiplexes wavelengths for transmission optical signals using a WDM optical fiber coupler. The thin film filter type three-port devices can separate received optical signals, as they are able to achieve high isolation, while the optical signals for transmission can be multiplexed using low-cost WDM optical fiber couplers. In this way, costs can be reduced with a wavelength division multiplexer configured in part of a WDM optical fiber coupler.

These aspects of the present invention and others will be described within the scope of the claims in more detail in the embodiments below.

### BRIEF DESCRIPTION OF THE DRAWINGS

In the drawings:

FIG. 1 is an explanatory diagram showing a wavelength division multiplexer according to a first embodiment of the present invention;

FIG. 2 is a graph showing the characteristics of the wavelength division multiplexer of FIG. 1;

FIG. 3 is an explanatory diagram showing the usage of the wavelength division multiplexer in FIG. 1 as a splitter and combiner;

FIG. 4 is an explanatory diagram showing the configuration of a wavelength division multiplexing system employing the wavelength division multiplexer of FIG. 1;

FIG. 5 is an explanatory diagram showing a wavelength division multiplexer according to a second embodiment of the present invention;

FIG. 6 is an explanatory diagram showing a wavelength division multiplexer according to a third embodiment of the present invention;

FIG. 7 is an explanatory diagram showing a wavelength division multiplexer according to a fourth embodiment of the present invention;

FIG. 8 is a graph showing the characteristics of an edge filter type thin film filter;

FIG. 9 is a graph showing the characteristics of a WDM optical fiber coupler;

FIG. 10 is an explanatory diagram showing a conventional wavelength division multiplexer employing thin film filter type three-port devices;

FIG. 11 shows the configuration of a thin film filter type three-port device used in the conventional wavelength division multiplexer of FIG. 10; and

FIG. 12 is an explanatory diagram showing a conventional wavelength division multiplexer employing a WDM optical fiber coupler.

### PREFERRED EMBODIMENTS

A wavelength division multiplexer according to preferred embodiments of the present invention will be described while referring to the accompanying drawings.

[First Embodiment]

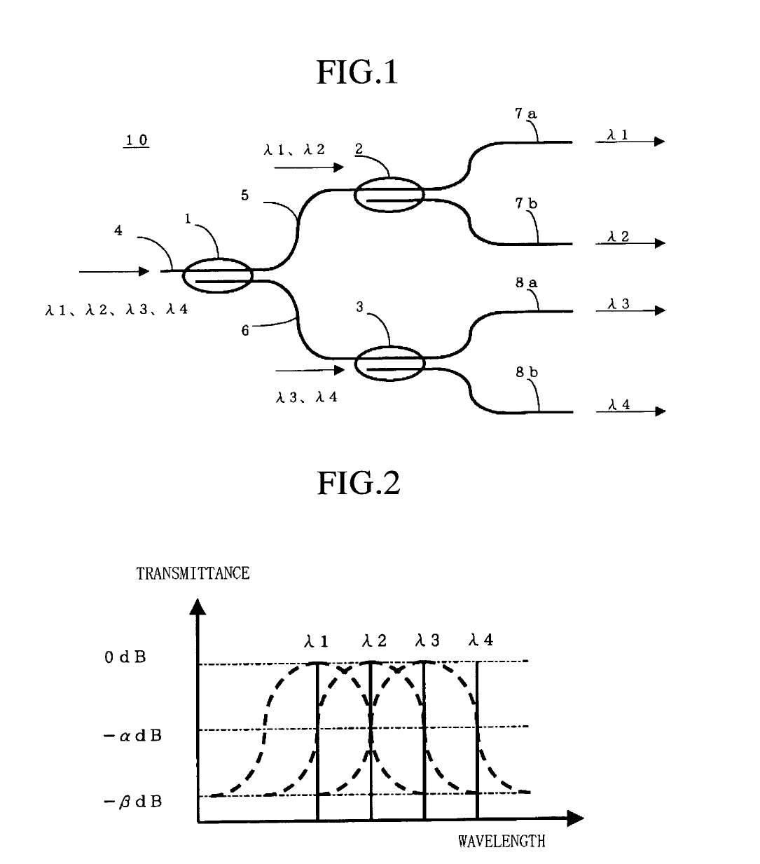

FIG. 1 shows a wavelength division multiplexer 10 employing WDM optical fiber couplers according to a first embodiment of the present invention. The wavelength division multiplexer 10 comprises a first WDM optical fiber coupler 1, a second WDM optical fiber coupler 2, and a third WDM optical fiber coupler 3 that are connected in a tree-like construction. Light comprising wavelengths λ1, λ2, λ3, and λ4 is introduced via an input port 4 into the first WDM optical fiber coupler 1. The first WDM optical fiber coupler 1 guides the λ1 and λ2 light to a port 5 and the λ3 and λ4 light to a port 6. The second WDM optical fiber coupler 2 further guides the λ1 to a port 7a and the λ2 to a port 7b. Similarly the third WDM optical fiber coupler 3 guides the λ3 to a port 8a and the λ4 to a port 8b.

FIG. 2 shows the characteristics of the wavelength division multiplexer 10 having the WDM optical fiber couplers described above. While light primarily of the wavelength λ1 is guided to the port 7a, α dB of light of the wavelength λ2 that should be guided to the neighboring port 7b leaks into the port 7a. In addition, β dB of light of the wavelength λ3 that should be guided to the port 8a adjacent to the neighboring port 7b leaks into the port 7a. In the present embodiment, the value for α is 9-17 dB, while the value for β is 20 dB or greater and preferably 20-40 dB.

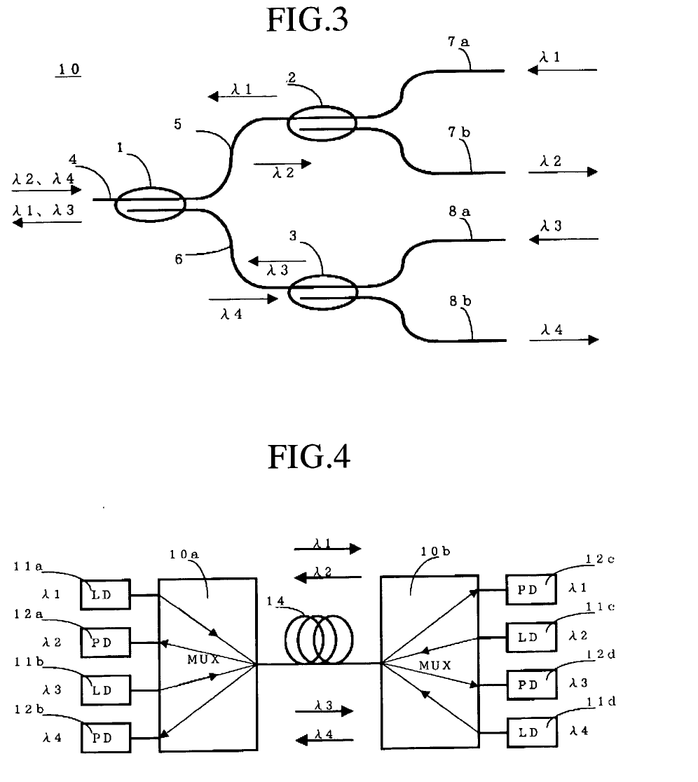

The wavelength division multiplexer 10 of the present embodiment is employed as a splitter. The wavelength division multiplexer 10 separates light received via the input port 4 into light of the wavelengths λ1, λ2, λ3, and λ4 and outputs these wavelengths from the ports 7a, 7b, 8a, and 8b, respectively. It is obvious that the wavelength division multiplexer 10 of the present embodiment can also be used as a combiner. Further, it is possible to use part of the wavelength division multiplexer 10 as a splitter and another part as a combiner. As shown in FIG. 3, for example, light of the wavelengths λ2 and λ4 inputted via the input port 4 can be separated and outputted via the ports 7b and 8b. Light of the wavelengths λ1 and λ3 inputted via the ports 7a and 8a can be combined and outputted via the input port 4. The wavelength division multiplexer 10 configured as shown in FIG. 3 can be used as a multiplexer 10a in a wavelength division multiplexing system described with reference to FIG. 4 below. (A multiplexer 10b in FIG. 4 separates wavelengths λ1 and λ3 and combines wavelengths λ2 and λ4.)

On one end, the system in FIG. 4 comprises a laser diode 11a for generating light of the wavelength λ1, a laser diode 11b for generating light of the wavelength λ3, a photodetector 12a for receiving light of the wavelength λ2, and a photodetector 12b for receiving light of the wavelength λ4. A first multiplexer 10a with a WDM optical fiber coupler multiplexes wavelengths received from the laser diode 11a and laser diode 11b and transmits the multiplexed signal to a receiving station (opposing station) on the other end via an optical fiber 14 for transmission. The opposing station comprises a laser diode 11c for generating light of the wavelength λ2, a laser diode 11d for generating light of the wavelength λ4, an photodetector 12c for receiving light of the wavelength λ1, and an photodetector 12d for receiving light of the wavelength λ3. A second multiplexer 10b with a WDM optical fiber coupler multiplexes light received from the laser diode 11c and laser diode 11d and transmits the light to an opposing station via the optical fiber 14.

In a system with the configuration described above, light of the wavelength λ1 is transferred from left to right via the optical fiber 14 (from the first multiplexer 10a to the second multiplexer 10b). Light of the wavelength λ2 is transferred from right to left via the optical fiber 14 (from the second multiplexer 10b to the first multiplexer 10a). Light of the wavelength λ3 is transferred from left to right (from the first multiplexer 10a to the second multiplexer 10b). Light of the wavelength λ4 is transferred from right to left (from the second multiplexer 10b to the first multiplexer 10a).

In a wavelength division multiplexing system, isolation between two wavelengths on the reception end must be 20 dB or greater. However, when changing wavelengths in a single optical fiber to perform bi-directional transmissions, as described above, the isolation between the reception signal and transmission signal need only be 10 dB or greater.

Since the transmission wavelengths and reception wavelengths are provided alternately in the wavelength division multiplexing system shown in FIG. 4, the wavelengths can share the same optical fiber even with relatively low isolation between neighboring wavelengths. With this quality, the wavelength division multiplexer 10 of FIG. 1 having the characteristics shown in FIG. 2 can be used to perform optical signal transmissions with no problem.

The above embodiment describes a wavelength division multiplexer capable of handling four wavelengths. However, it is obvious that the present invention can be applied to six, eight, or an arbitrary number of wavelengths. The present invention can also be applied when using three, five, seven, or another odd number of wavelengths.

[Second Embodiment]

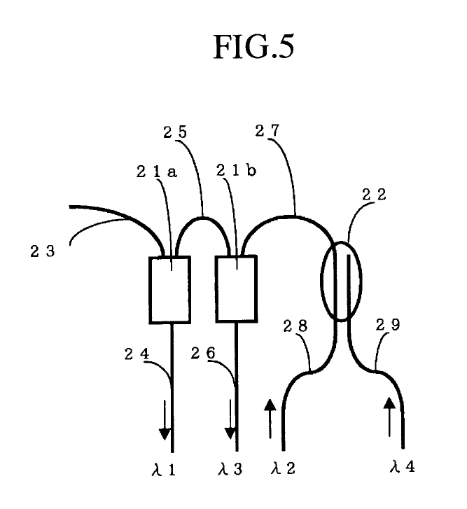

A wavelength division multiplexer according to a second embodiment of the present invention will be described with reference to FIG. 5. In the second embodiment, the wavelength division multiplexer comprises thin film filter type three-port devices 21a and 21b, a WDM optical fiber coupler 22, and optical fibers 25 and 27 for connecting the three-port devices 21a and 21b and the WDM optical fiber coupler 22 in a hybrid configuration. Light from an input/output port 23 of the wavelengths λ1 and λ3 is introduced into the three-port device 21a. Light of the wavelength λ1 passes through the three-port device 21a and is guided to a port 24, while light of the wavelength λ3 travels to the three-port device 21b via the three-port device 21a and optical fiber 25, passes through the three-port device 21b, and is guided to a port 26. In addition, light of the wavelength λ2 is inserted via a port 28 and is guided to the optical fiber 27 via the WDM optical fiber coupler 22. Light of the wavelength λ4 is inserted via a port 29 and is guided to the optical fiber 27 via the WDM optical fiber coupler 22. Subsequently, light of the wavelengths λ2 and λ4 pass through the three-port devices 21b and 21a and are guided to the input/output port 23.

Since thin film filter type three-port devices have satisfactory isolating properties, these devices are employed on the receiving end. However, a WDM optical fiber coupler that is cost-effective but does not have particularly good isolating properties is employed on the transmission end. With this construction, it is possible to achieve a cost-effective wavelength division multiplexer that can be applied to the wavelength division multiplexing system having the construction shown in FIG. 4.

It is obvious to those skilled in the art, that the wavelength division multiplexer shown in FIG. 5 can be constructed to handle an arbitrary number of wavelengths. Hence, the present invention is not limited to four wavelengths. It is possible to increase the number of multiplexed wavelengths by increasing the number of thin film filter type three-port devices and connecting these devices in tandem. Further, WDM optical fiber couplers connected in a tree-like structure can also be connected in tandem to the thin film filter type three-port devices. It is also possible to configure the wavelength division multiplexer such that the three-port devices separate sequential wavelengths into neighboring wavelengths, such as λ1 and λ2. In this case, the WDM optical fiber couplers are configured to multiplex neighboring wavelengths, such as λ3 and λ4.

[Third Embodiment]

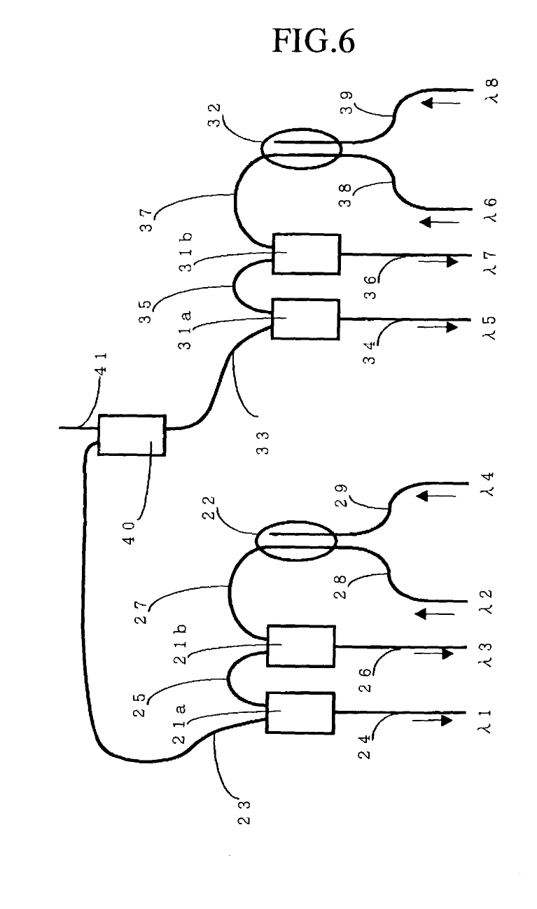

Next, a wavelength division multiplexer according to a third embodiment of the present invention will be described with reference to FIG. 6. In the present embodiment, a three-port device 40 configured of edge filter type thin film filters separates eight optical signals λ1 through λ8 into short wavelength bands (λ1, λ2, λ3, and λ4) and long wavelength bands (λ5, λ6, λ7, and λ8). Subsequently, wavelength division multiplexers having the same construction as the wavelength division multiplexer of the second embodiment shown in FIG. 5 perform multiplexing. Unlike a bandpass filter, an edge filter reflects (or passes) light of a wavelength shorter than a specific wavelength and passes (or reflects) light of a longer wavelength. When optical signals are received from an input/output port 41, the three-port device 40 transfers short wavelength bands to the input/output port 23 end and transfers long wavelength bands to a port 33 end.

As described in the second embodiment, the wavelength division multiplexer on the short wavelength end comprises the thin film filter type three-port devices 21a and 21b, the WDM optical fiber coupler 22, and the optical fibers 25 and 27 for connecting the three-port devices 21a and 21b and the WDM optical fiber coupler 22 in a hybrid configuration. Light from the input/output port 23 of the wavelengths λ1 and λ3 is introduced into the three-port device 21a. Light of the wavelength λ1 is guided to the port 24, while light of the wavelength λ3 is guided to the port 26. In addition, light of the wavelength λ2 is guided to the optical fiber 27 via the port 28 and the WDM optical fiber coupler 22. Light of the wavelength λ4 is guided to the optical fiber 27 via the port 29 and the WDM optical fiber coupler 22. Light of the wavelengths λ2 and λ4 then passes through the three-port devices 21b and 21a and is guided to the input/output port 23.

Similarly, the wavelength division multiplexer on the long wavelength end comprises thin film filter type three-port devices 31a and 31b, a WDM optical fiber coupler 32, and optical fibers 35 and 37 for connecting the three-port devices 31a and 31b and the WDM optical fiber coupler 32 in a hybrid configuration. Light from the input/output port 33 of the wavelengths λ5 and λ7 is introduced into the three-port device 31a. Light of the wavelength λ5 is guided to a port 34, while light of the wavelength λ7 is guided to a port 36. In addition, light of the wavelength λ6 is guided to the optical fiber 37 via a port 38 and the WDM optical fiber coupler 32. Light of the wavelength λ8 is guided to the optical fiber 37 via a port 39 and the WDM optical fiber coupler 32. Light of the wavelengths λ6 and λ8 then passes through the three-port devices 31b and 31a and is guided to the input/output port 33.

As an example, λ1 is 1470 nm; λ2 is 1490 nm; λ3 is 1510 nm; λ4 is 1530 nm; λ5 is 1550 nm; λ6 is 1570 nm; λ7 is 1590 nm; and λ8 is 1610 nm. By stacking edge filters in multiple stages, it is possible to create a wavelength division multiplexer for sixteen wavelengths or for a higher number of wavelengths.

[Fourth Embodiment]

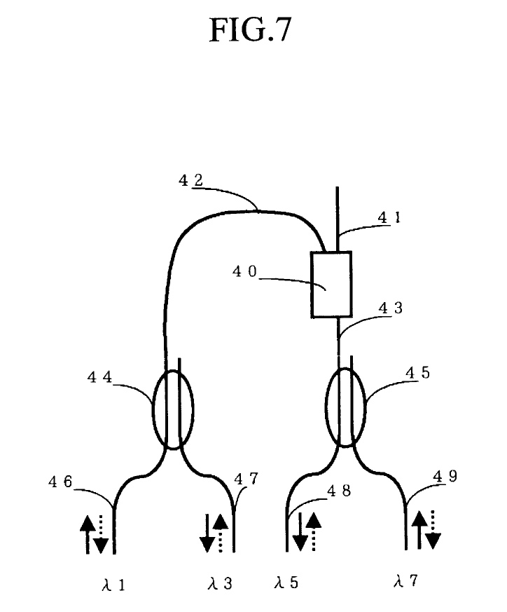

FIG. 7 shows a wavelength division multiplexer according to a fourth embodiment of the present invention. The wavelength division multiplexer of the fourth embodiment comprises the three-port device 40, a WDM optical fiber coupler 44, and a WDM optical fiber coupler 45.

An optical signal of the wavelength λ1 inputted into a port 46 passes through the WDM optical fiber coupler 44, a port 42, and the three-port device 40 and is transmitted to the input/output port 41. Light of the wavelength λ3 inputted into the input/output port 41 passes through the three-port device 40, the port 42, and the WDM optical fiber coupler 44 and is transmitted to a port 47.

An optical signal of the wavelength λ7 inputted into a port 49 passes through the WDM optical fiber coupler 45, a port 43, and the three-port device 40 and is transferred to the input/output port 41. Light of the wavelength λ5 inputted into the input/output port 41 passes through the three-port device 40, the port 43, and the WDM optical fiber coupler 45 and is transferred to a port 48.

The optical signals can also be transferred in opposite directions than those described above. The arrows with solid lines in FIG. 7 show the direction of optical signals according to the above description, while the arrows indicated by dotted lines in the drawing show the direction of optical signals opposite to the direction in the above description.

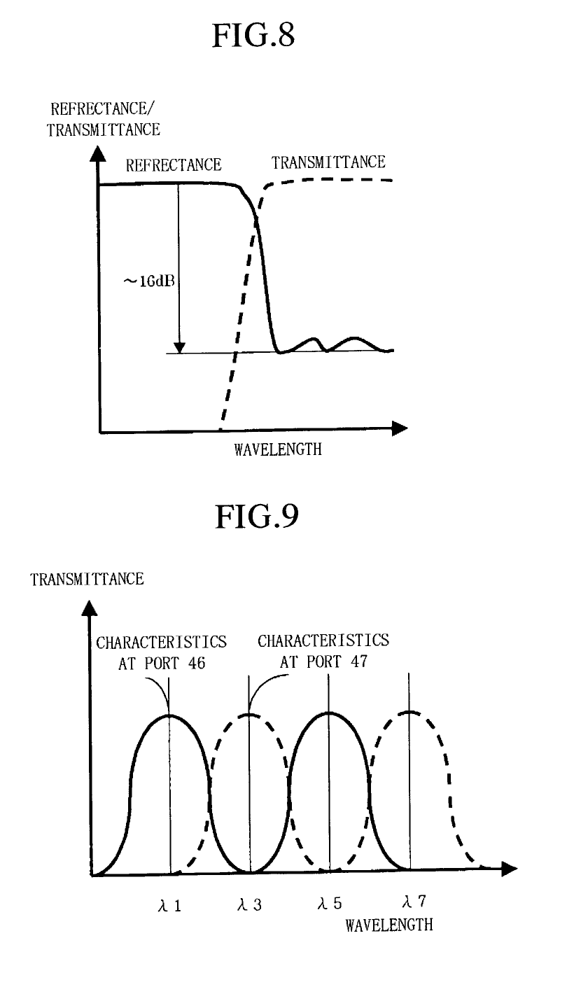

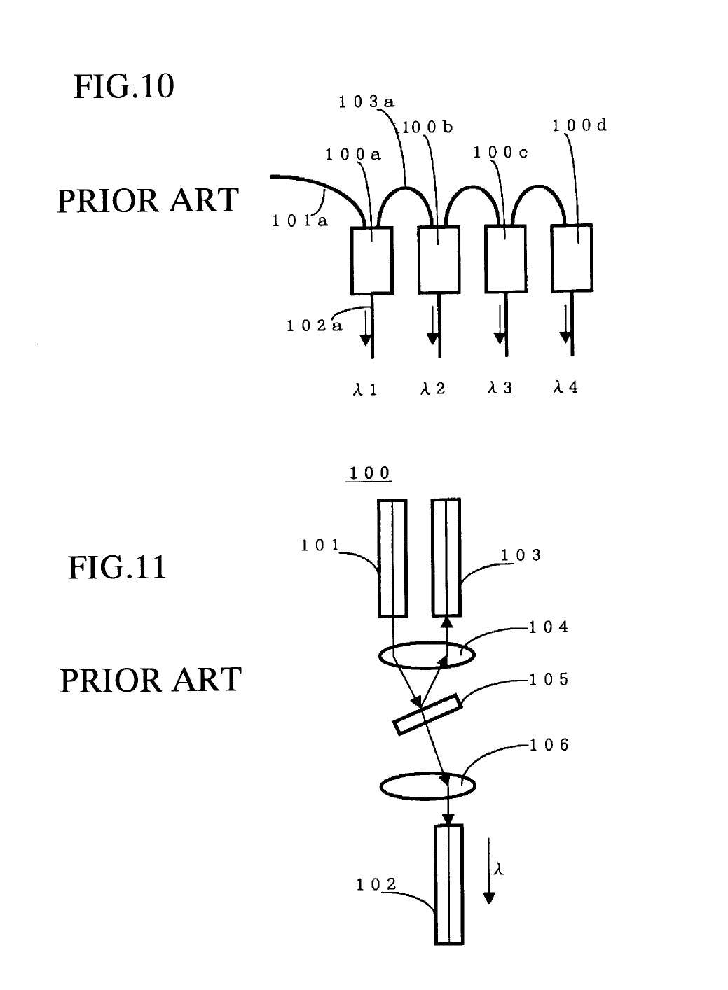

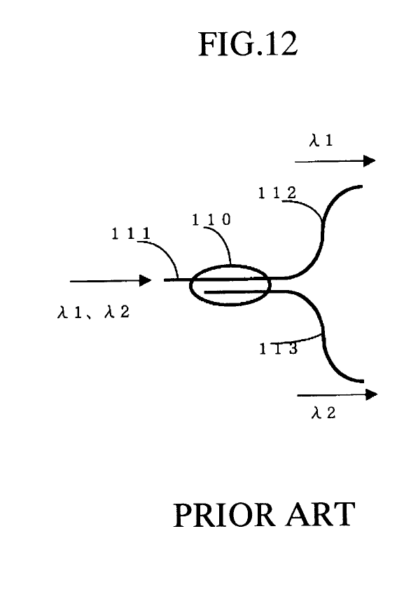

A feature of the present embodiment is configuring light of the wavelengths λ1 and λ7 to travel in the same direction and light of the wavelengths λ3 and λ5 to travel in the same direction. Here, direction denotes either the direction of input and the direction of output. Saying that a plurality of optical signals travel in the same direction means that the signals have either the same direction of input or the same direction of output. FIG. 8 shows the characteristics of reflected light and transmitted light in the three-port device 40. As far as transmitted light is concerned, light of a wavelength not intended for passage is blocked at an extremely high ratio. However, a considerably large ratio of light not intended for reflection is reflected. Looking back at FIG. 7, the three-port device 40 is not designed to reflect light of the wavelength λ5 to the port 42 end. In reality, however, reflectance of about −16 dB occurs. The optical signal of the wavelength λ5 acts as an interference wave to the optical signal of wavelength λ3.

FIG. 9 shows the transmittance characteristics of optical signals transferred to the ports 46 and 47 of the WDM optical fiber coupler 44. It is known that the WDM optical fiber coupler 44 has periodic transmittance characteristics in relation to wavelength. If we focus on the characteristics at the port 47, note that while light of the wavelength λ5 does not pass through to the port 47, light of the wavelength λ7 does. If the wavelength device in FIG. 7 were configured differently such that light of the wavelength λ7 were received from the input/output port 41 end, then light of the wavelength λ7 would become an interference wave and be transmitted to the WDM optical fiber coupler 44 via the port 42. Moreover, the λ7 interference wave would continue to the port 47. In contrast, the WDM optical fiber coupler in the wavelength system of FIG. 7 prevents the λ5 barrier wave from being transferred to the port 47, thereby reducing the proportion of the interference wave.

In the present embodiment, it is obvious that the three-port devices configured of edge filter type thin film filters can be further stacked in multiple layers to form an eight-wavelength type or sixteen-wavelength type construction.

The present invention can achieve a wavelength division multiplexer employing a WDM optical fiber coupler with low isolation that has a remarkable effect on reducing the costs of the wavelength division multiplexer and wavelength division multiplexing system.

What is claimed is:

1. A wavelength division multiplexer comprising a single common port and three or more branch ports such that light received via the common port is split into at least three optical signals of different wavelengths that are transferred to corresponding branch ports, wherein an isolation α between a first wavelength and a second wavelength adjacent to the first wavelength is set to 10-17 dB and an isolation β between the first wavelength and a third wavelength adjacent to the second wavelength is set to 20 dB or greater.

2. A wavelength division multiplexer as recited in claim 1, wherein the value of β is set to 20-40 dB.

3. A wavelength division multiplexer as recited in claim 1, further comprising a plurality of WDM optical fiber couplers connected in a tree-like structure.

4. A wavelength division multiplexer comprising a thin film filter type three-port device and WDM optical fiber coupler connected in tandem.

5. A wavelength division multiplexer comprising a thin film filter type three-port device and a WDM optical fiber coupler, wherein one of branch ports of the three-port device is connected to a common port of the WDM optical fiber coupler.

6. A wavelength division multiplexer as recited in claim 5, wherein one or more other thin film filter type three-port devices are connected to the thin film filter type three-port device connected to the WDM optical fiber coupler, such that a branch port of one thin film filter type three-port device is connected to a common port of another thin film filter type three-port device.

7. A wavelength division multiplexer as recited in claim 5, wherein the thin film filter type three-port devices separate received optical signals into wavelengths, while the WDM optical fiber coupler multiplexes optical signals for transmission.

8. A wavelength division multiplexer comprising a first thin film filter type three-port device for separating received light into optical signals of a short wavelength band and optical signals of a long wavelength band, and two wavelength division multiplexer units;
the common port of each wavelength division multiplexer units being connected to a corresponding branch port of the first thin film filter type three-port device; and
each of the two wavelength division multiplexer units comprising a second thin film filter type three-port device and a WDM optical fiber coupler, wherein one of branch ports of the second three-port device is connected to a common port of the WDM optical fiber coupler.

9. A wavelength division multiplexer comprising a thin film filter type three-port device for separating received light into optical signals of a short wavelength band and optical signals of a long wavelength band, and two wavelength WDM optical fiber couplers, wherein the common port of each WDM optical fiber coupler is connected to a branch port of the thin film filter type three-port device.

10. A wavelength division multiplexing system employing one or more wavelength division multiplexers and configured to perform bi-directional communications over a single optical fiber, while using opposite transmission directions for neighboring wavelengths,
each of the wavelength division multiplexers A wavelength division multiplexer comprising a single common port and three or more branch ports such that light received via the common port is split into at least three optical signals of different wavelengths that are transferred to corresponding branch ports, wherein an isolation α between a first wavelength and a second wavelength adjacent to the first wavelength is set to 10-17 dB and an isolation β between the first wavelength and a third wavelength adjacent to the second wavelength is set to 20 dB or greater.

11. A wavelength division multiplexing system employing one or more wavelength division multiplexers and configured to perform bi-directional communications over a single optical fiber, while using opposite transmission directions for neighboring wavelengths,
each of the wavelength division multiplexers comprising a thin film filter type three-port device and WDM optical fiber coupler connected in tandem..

12. A wavelength division multiplexing system employing one or more wavelength division multiplexers and configured to perform bi-directional communications over a single optical fiber, while using opposite transmission directions for neighboring wavelengths,
each of the wavelength division multiplexers comprising a thin film filter type three-port device and a WDM optical fiber coupler, wherein one of branch ports of the three-port device is connected to a common port of the WDM optical fiber coupler.

13. A wavelength division multiplexing system employing one or more wavelength division multiplexers and configured to perform bi-directional communications over a single optical fiber, while using opposite transmission directions for neighboring wavelengths,
each of the wavelength division multiplexers comprising a first thin film filter type three-port device for separating received light into optical signals of a short wavelength band and optical signals of a long wavelength band, and two wavelength division multiplexer units,
the common port of each wavelength division multiplexer units being connected to a corresponding branch port of the first thin film filter type three-port device, and
each of the two wavelength division multiplexer units comprising a second thin film filter type three-port device and a WDM optical fiber coupler, wherein one of branch ports of the second three-port device is connected to a common port of the WDM optical fiber coupler.

14. A wavelength division multiplexing system employing one or more wavelength division multiplexers and configured to perform bi-directional communications over a single optical fiber, while using opposite transmission directions for neighboring wavelengths,
each of the wavelength division multiplexers comprising a thin film filter type three-port device for separating received light into optical signals of a short wavelength band and optical signals of a long wavelength band, and two wavelength WDM optical fiber couplers, wherein the common port of each WDM optical fiber coupler is connected to a branch port of the thin film filter type three-port device.
